(19) United States
(12) Patent Application Publication
(10) Pub. No.: US 2017/0111402 A1
(43) Pub. Date: Apr. 20, 2017

(54) CALL METHOD, CALL APPARATUS, VOIP SERVER, AND CALL SYSTEM

(71) Applicant: Huawei Technologies Co., Ltd., Shenzhen, Guangdong (CN)

(72) Inventor: Wenhu Zhang, Shenzhen (CN)

(21) Appl. No.: 15/126,984

(22) PCT Filed: Mar. 19, 2014
(86) PCT No.: PCT/CN2014/073709

§ 371 Date: Sep. 16, 2016

(51) Int. Cl. H04L 29/06; H04M 7/00; H04W 8/12

(52) U.S. Cl. CPC H04L 65/1066; H04W 8/12; H04L 65/102; H04M 7/006

(57) ABSTRACT

This application provides a call method, a call apparatus, a VOIP server, and a call system. The call method includes: receiving, by a VOIP server, a first call request that is forwarded by a first VOIP gateway and that includes a local identifier; acquiring, by the VOIP server according to a prestored association relationship, a destination identifier that corresponds to the local identifier; searching, by the VOIP server, for a visited location GMSC to which the destination identifier belongs; and sending, by the VOIP server, a second call request including the destination identifier to the visited location GMSC, so that the visited location GMSC calls the destination identifier.

### CROSS REFERENCE TO RELATED APPLICATIONS

The present application claims priority under 35 U.S.C. §365 to International Patent Application No. PCT/CN2014/073709 filed Mar. 19, 2014 which is incorporated herein by reference in its entirety.

### TECHNICAL FIELD

The present invention relates to the field of communications, and in particular, to a call method, a call apparatus, a VOIP server, and a call system.

### BACKGROUND

After a user leaves a home location to which a local terminal belongs and arrives at a visited location, usually, the user hopes to still be able to answer a local call. The local terminal refers to a mobile terminal such as a mobile phone that the user applies for in a home location network. The local call refers to a call made by a calling user to the local terminal. For example, when being abroad, a mobile phone user usually hopes to still be able to answer a call made by a domestic calling user to a mobile phone number used at home.

In the prior art, answering a local call at a visited location is usually implemented based on roaming. Roaming refers to that a local terminal uses, in a telecommunication network outside a home location network, namely, a visited location network, telecommunications services such as a voice call and data transmission, to maintain communication uninterrupted. Implementation of roaming requires an interconnection between the visited location network and the home location network. However, in an actual situation, the home location network and the visited location network are usually provided by different operators. To achieve an interconnection between the home location network and the visited location network, an operator of the visited location network needs to sign a settlement agreement with an operator of the home location network, and moreover, a network connection test needs to be performed. The interconnection between the visited location network and the home location network can be implemented only after the settlement agreement is signed and the network connection test succeeds.

If a user wants to answer a local call at a visited location, a visited location network and a home network need to be interconnected, and moreover, a roaming service needs to be enabled for the local terminal in the home network. Only after the roaming service is enabled, does a home location GMSC route, to the visited location network, a call request used to call the local terminal, and then the visited location network routes the call request to the local terminal, so as to enable the user to use the local terminal to answer an incoming call at the visited location.

It can be seen from the foregoing content that when the prior art is used to implement answering a local call at a visited location, a visited location network and a home location network need to be interconnected, and moreover, a user needs to enable a roaming service. An implementation process is complex.

### SUMMARY

Embodiments of the present invention provide a call method, a call apparatus, a VOIP server, and a call system, to resolve a problem in the prior art that an implementation process of answering a local call at a visited location is complex.

According to a first aspect, an embodiment of the present invention provides a call method, including: receiving, by a VOIP server, a first call request that is forwarded by a first VOIP gateway and that includes a local identifier; acquiring, by the VOIP server according to a prestored association relationship, a destination identifier that corresponds to the local identifier; searching, by the VOIP server, for a visited location GMSC to which the destination identifier belongs; and sending, by the VOIP server, a second call request including the destination identifier to the visited location GMSC, so that the visited location GMSC calls the destination identifier.

With reference to the first aspect, in a first possible implementation manner of the first aspect, the receiving, by a VOIP server, a first call request that is forwarded by a first VOIP gateway and that includes a local identifier includes: receiving, by the VOIP server, the first call request that is forwarded by the first VOIP gateway and that includes the local identifier, where the first call request is generated by the home location GMSC and is used to call a gateway number of the first VOIP gateway.

With reference to the first aspect or the first possible implementation manner of the first aspect, in a second possible implementation manner of the first aspect, the VOIP server sends the second call request to a second gateway, so that the second gateway forwards the second call request to the visited location GMSC.

According to a second aspect, an embodiment of the present invention provides another call method, including: generating, by a home location GMSC, a first call request including a local identifier; sending, by the home location GMSC, the first call request to a VOIP server; acquiring, by the VOIP server according to a prestored association relationship, a destination identifier that corresponds to the local identifier; searching, by the VOIP server, for a visited location GMSC to which the destination identifier belongs; sending, by the VOIP server, a second call request including the destination identifier to the visited location GMSC; and calling, by the visited location GMSC, the destination identifier.

With reference to the second aspect, in a first possible implementation manner of the second aspect, the generating, by a home location GMSC, a first call request including a local identifier includes: generating, by the home location GMSC, the first call request including the local identifier after receiving a local call request used to call the local identifier.

With reference to the second aspect or the first possible implementation manner of the second aspect, in a second possible implementation manner of the second aspect, the sending, by the VOIP server, a second call request including the destination identifier to the visited location GMSC includes: sending, by the VOIP server, the second call request including the destination identifier to a second VOIP gateway; and receiving, by the visited location GMSC, the second call request forwarded by the VOIP server.

According to a third aspect, an embodiment of the present invention provides a call apparatus, including: a receiving unit, configured to receive a first call request that is forwarded by a first VOIP gateway and that includes a local identifier; an acquiring unit, configured to acquire, according to a prestored association relationship, a destination identifier that corresponds to the local identifier received by the receiving unit; a querying unit, configured to search for a visited location GMSC to which the destination identifier acquired by the acquiring unit belongs; and a sending unit, configured to send a second call request including the destination identifier to the visited location GMSC obtained by querying by the querying unit, so that the visited location GMSC calls the destination identifier.

With reference to the third aspect, in a first possible implementation manner of the third aspect, the receiving unit is further configured to receive the first call request that is forwarded by the first VOIP gateway and that includes the local identifier, where the first call request is generated by the home location GMSC and is used to call a gateway number of the first VOIP gateway.

With reference to the third aspect or the first possible implementation manner of the third aspect, in a second possible implementation manner of the third aspect, the sending unit is configured to send the second call request to a second gateway, so that the second gateway forwards the second call request to the visited location GMSC and the visited location GMSC calls the destination identifier.

According to a fourth aspect, an embodiment of the present invention provides a VOIP server, including: a transceiver apparatus, configured to receive a first call request that is forwarded by a first VOIP gateway and that includes a local identifier; and a processor, configured to acquire, according to a prestored association relationship, a destination identifier that corresponds to the local identifier; and search for a visited location GMSC to which the destination identifier belongs, where the transceiver apparatus is further configured to send a second call request including the destination identifier to the visited location GMSC, so that the visited location GMSC calls the destination identifier.

With reference to the fourth aspect, in a first possible implementation manner of the fourth aspect, the transceiver apparatus is further configured to receive the first call request that is forwarded by the first VOIP gateway and that includes the local identifier, where the first call request is generated by the home location GMSC and is used to call a gateway number of the first VOIP gateway.

With reference to the fourth aspect or the first possible implementation manner of the fourth aspect, in a second possible implementation manner of the fourth aspect, the transceiver apparatus is further configured to send the second call request to a second gateway, so that the second gateway forwards the second call request to the visited location GMSC and the visited location GMSC calls the destination identifier.

According to a fifth aspect, an embodiment of the present invention provides a call system, including: a home location GMSC, configured to generate a first call request including a local identifier, and send the first call request to a VOIP server; the VOIP server, configured to receive the first call request, acquire, according to a prestored association relationship, a destination identifier that corresponds to the local identifier, search for a visited location GMSC to which the destination identifier belongs, and send a second call request including the destination identifier to the visited location GMSC; and the visited location GMSC, configured to call the destination identifier after receiving the second call request.

With reference to the fifth aspect, in a first possible implementation manner of the fifth aspect, the home location GMSC is further configured to generate the first call request including the local identifier after receiving a local call request used to call the local identifier.

By using the embodiments of the present invention, a first call request is received, where the first call request includes a local identifier; if an association relationship between the local identifier and a destination identifier is stored on the VOIP server, the destination identifier that corresponds to the local identifier is acquired according to the association relationship; and the destination identifier is called. By only requiring that a home location network and a visited location network separately establish an interconnection to a VOIP network, and that the association relationship between the local identifier and the destination identifier is stored on the VOIP server, after a user starts, for the local identifier, call forwarding in which a forwarded-to number is a gateway number of the VOIP network, answering a local call at a visited location by using a destination identifier can be implemented. An implementation process is simple.

### BRIEF DESCRIPTION OF THE DRAWINGS

To describe the technical solutions in the embodiments of the present invention more clearly, the following briefly introduces the accompanying drawings required for describing the embodiments or the prior art. Apparently, a person of ordinary skill in the art may still derive other drawings from these accompanying drawings without creative efforts.

FIG. 1A is a flowchart of an embodiment of a call method according to the present invention;

FIG. 1B is a flowchart of an embodiment of a call method according to the present invention;

FIG. 2 is a block diagram of an embodiment of a call apparatus according to the present invention;

FIG. 3 is a block diagram of an embodiment of a VOIP server according to the present invention; and

FIG. 4 is a block diagram of an embodiment of a call system according to the present invention.

### DETAILED DESCRIPTION

To make a person skilled in the art understand the technical solutions in the present invention better, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

With development of an Internet VOIP technology, using a Voice over Internet Protocol (VOIP, Voice over Internet Protocol) technology to carry a real-time voice call has been made possible. Therefore, with the help of a VOIP network, answering a local call at a visited location may be implemented by using an existing call forwarding technology. The VOIP network usually includes one VOIP server and multiple VOIP gateways. The VOIP gateway is configured to complete communication between the VOIP network and another network. Each VOIP gateway has a gateway number. Before the embodiments of the present invention are used to implement answering a local call at a visited location, a local terminal needs to start call forwarding during which the VOIP server is used as a forwarding destination. For example, a call forwarded-to number of the local identifier may be set in advance to be a gateway number of a first VOIP gateway between the VOIP server and a home location GMSC. The present invention is described in the following with reference to the VOIP server.

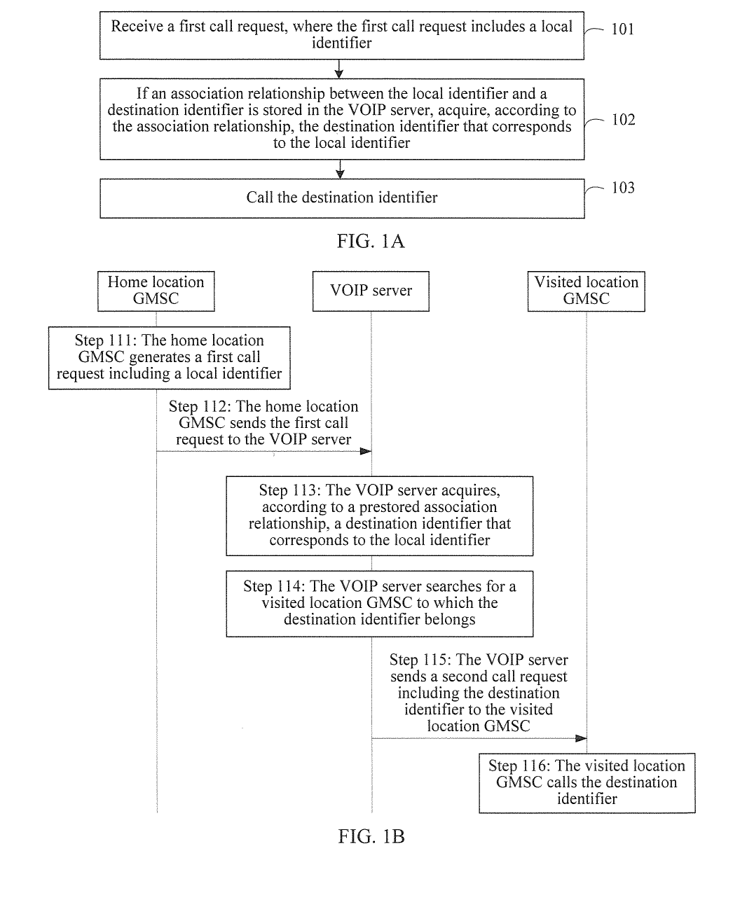

Referring to FIG. 1A, FIG. 1A is a flowchart of an embodiment of a call method according to the present invention.

Step 101: A VOIP server receives a first call request that is forwarded by a first VOIP gateway and that includes a local identifier.

The VOIP server receives the first call request including the local identifier. The first call request may be generated by a home location GMSC. The local identifier may be an identifier that can represent a local terminal. For example, when the local terminal is a mobile phone, the local identifier may be a mobile phone number. The first call request may be generated by the home location GMSC and directly or indirectly sent to the VOIP. The first call request may also be generated by another device, which is not described in detail herein.

Step 102: The VOIP server acquires, according to a prestored association relationship, a destination identifier that corresponds to the local identifier.

After receiving the first call request, the VOIP server first detects whether the association relationship between the local identifier and the destination identifier is prestored. The destination identifier may be a mobile phone number, and the association relationship may be prestored on the VOIP server by technical personnel.

If the association relationship between the local identifier and the destination identifier is stored on the VOIP server, the VOIP server acquires, according to the association relationship, the destination identifier that corresponds to the local identifier. If the association relationship is not stored on the VOIP server, the VOIP server may process the first call request according to a general processing manner. A specific process is not described in detail herein.

Step 103: The VOIP server searches for a visited location GMSC to which the destination identifier belongs.

In practical use, the VOIP server may be interconnected to multiple GMSCs simultaneously. Therefore, in practical use, the visited location GMSC to which the destination identifier belongs needs to be determined. There are multiple manners of determining the visited location GMSC according to the destination identifier. For example, when the destination identifier is a mobile phone number, the visited location GMSC may be determined according to a belonging of the mobile phone number.

It should be noted herein that the destination identifier may also belong to a VOIP network on which the VOIP server is located or another VOIP network. A specific corresponding call manner is not described in detail herein.

Step 104: The VOIP server sends a second call request including the destination identifier to the visited location GMSC, so that the visited location GMSC calls the destination identifier.

After the visited location GMSC is determined, the VOIP server may send the second call request to the visited location GMSC. After receiving the second call request, the visited location GMSC sends, to a visited location VLR, a query request for a home location of the destination identifier. After obtaining, by querying, the home location of the destination identifier according to the query request, the visited location VLR sends the home location to the visited location GMSC. The visited location GMSC calls the destination terminal by using a visited location VMSC/VLR that corresponds to the home location.

In practical use, the VOIP server may send the second call request to a second gateway, and then the second gateway forwards the second call request to the visited location GMSC.

By using this embodiment, a VOIP server receives a first call request that is forwarded by a first VOIP gateway and that includes a local identifier; the VOIP server acquires, according to a prestored association relationship, a destination identifier that corresponds to the local identifier; the VOIP server searches for a visited location GMSC to which the destination identifier belongs; and the VOIP server sends a second call request including the destination identifier to the visited location GMSC, so that the visited location GMSC calls the destination identifier. After a home location network and a visited location network separately establish an interconnection to a VOIP network, answering a local call at a visited location by using the destination identifier can be implemented by only requiring that a user stores the association relationship between the local identifier and the destination identifier on the VOIP server and that the user starts call forwarding and sets a number for the call forwarding to be a gateway number of the VOIP network. An implementation process is simple. Because the call is implemented by using the VOIP network, it is very convenient for a user abroad to answer a domestic call, which not only avoids a complex process of enabling a roaming service but also saves call costs for the user.

Referring to FIG. 1B, FIG. 1B is a flowchart of another embodiment of a call method according to the present invention. As shown in FIG. 1B, the method includes the following steps.

Step 111: A home location GMSC generates a first call request including a local identifier.

For example, when a domestic calling user calls a domestic mobile phone number, a home location VMSC/VLR routes call signaling to the home location GMSC. After receiving the call signaling, the home location GMSC queries a home location HLR for location information of the mobile phone number. If a forwarded-to number of the mobile phone number has been set to be a gateway number C of a first VOIP gateway, the home location HLR returns C to the home location GMSC. After receiving C, the home location GMSC generates a first call request used to call C, where the first call request includes the mobile phone number that is originally called by the domestic calling user.

Step 112: The home location GMSC sends the first call request to a VOIP server.

The first call request used to call C is sent to the first VOIP gateway by the home location GMSC. The first VOIP gateway may be a gateway between the VOIP server and the GMSC. After receiving the first call request, the first VOIP gateway may adjust a signaling format of the first call request, to adjust the signaling format of the first call request to a signaling format that is suitable for VOIP network transmission, and then forwards the adjusted first call request to the VOIP server.

Step 113: The VOIP server acquires, according to a prestored association relationship, a destination identifier that corresponds to the local identifier.

Step 114: The VOIP server searches for a visited location GMSC to which the destination identifier belongs.

Step 115: The VOIP server sends a second call request including the destination identifier to the visited location GMSC.

Step 116: After receiving the second call request, the visited location GMSC calls the destination identifier.

For specific implementation manners of step 113 to step 116, reference may be made to the forgoing embodiment, and details are not described herein again.

By using this embodiment, after a home location network and a visited location network separately establish an interconnection to a VOIP network, answering a local call at a visited location by using a destination identifier can be implemented by only requiring that a user stores an association relationship between a local identifier and the destination identifier on a VOIP server and that the user starts call forwarding and sets a number for the call forwarding to be a gateway number of the VOIP network. implementation process is simple. Because the call is implemented by using the VOIP network, it is very convenient for a user abroad to answer a domestic call, which not only avoids a complex process of enabling a roaming service but also saves call costs for the user.

Corresponding to the call method in the present invention, the present invention further provides a call apparatus.

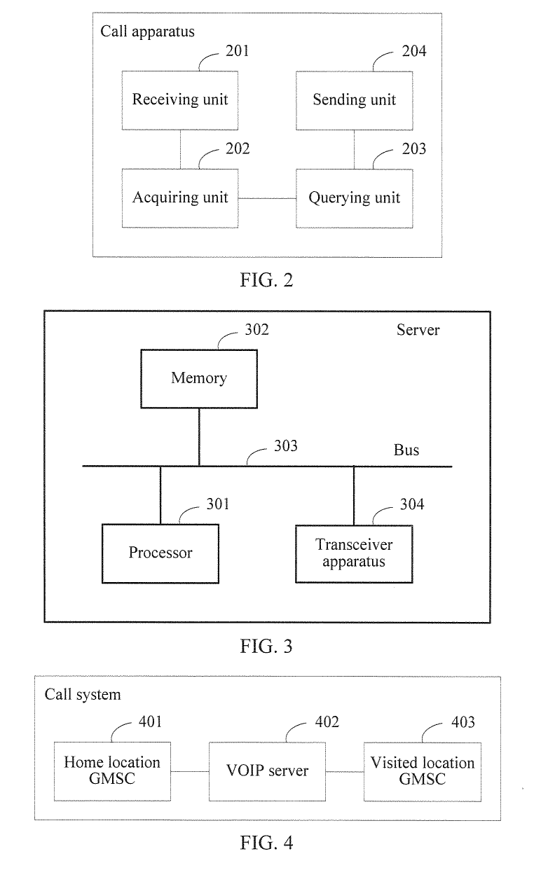

Referring to FIG. 2, FIG. 2 is a block diagram of an embodiment of a call apparatus according to the present invention.

As shown in FIG. 2, the apparatus includes: a receiving unit 201, an acquiring unit 202, a querying unit 203, and a sending unit 204.

The receiving unit 201 is configured to receive a first call request that is forwarded by a first VOIP gateway and that includes a local identifier. The receiving unit 201 is further configured to receive the first call request that is forwarded by the first VOIP gateway and that includes the local identifier, where the first call request is generated by the home location GMSC and is used to call a gateway number of the first VOIP gateway.

The acquiring unit 202 is configured to acquire, according to a prestored association relationship, a destination identifier that corresponds to the local identifier received by the receiving unit 201.

The querying unit 203 is configured to search for a visited location GMSC to which the destination identifier acquired by the acquiring unit 202 belongs.

The sending unit 204 is configured to send a second call request including the destination identifier to the visited location GMSC obtained by querying by the querying unit 203, so that the visited location GMSC calls the destination identifier. The sending unit may be further configured to send the second call request to a second gateway, so that the second gateway forwards the second call request to the visited location GMSC and the visited location GMSC calls the destination identifier.

By using this embodiment, after a home location network and a visited location network separately establish an interconnection to a VOIP network, answering a local call at a visited location by using a destination identifier can be implemented by only requiring that a user stores an association relationship between a local identifier and the destination identifier on a VOIP server, and that the user starts call forwarding and sets a number for the call forwarding to be a gateway number of the VOIP network. An implementation process is simple. Because the call is implemented by using the VOIP network, it is very convenient for a user abroad to answer a domestic call, which not only avoids a complex process of enabling a roaming service but also saves call costs for the user.

The call method in the embodiments of the present invention may be implemented by a VOIP server. FIG. 3 shows an embodiment of a server based on a computer system. It can be learned from FIG. 3 that, during specific implementation, a VOIP server of this embodiment of the present invention may include physical modules such as a processor 301, a memory 302, a bus 303, and a transceiver apparatus 304. The memory 302 is configured to store a computer execution instruction. The processor 301, the memory 302, and the transceiver apparatus 304 are connected by using the bus.

When the server is running, the processor 301 executes the computer execution instruction stored by the memory 302, and communicates with a device outside a cluster management device by using the transceiver apparatus 304, so that the server executes the call method described in the embodiments of the present invention.

Specifically, the transceiver apparatus 304 is configured to receive a first call request that is forwarded by a first VOIP gateway and that includes a local identifier. The processor 301 is configured to acquire, according to a prestored association relationship, a destination identifier that corresponds to the local identifier, and search for a visited location GMSC to which the destination identifier belongs. The transceiver apparatus 304 is further configured to send a second call request including the destination identifier to the visited location GMSC, so that the visited location GMSC calls the destination identifier.

The transceiver apparatus 304 is further configured to receive the first call request that is forwarded by the first VOIP gateway and that includes the local identifier, where the first call request is generated by the home location GMSC and is used to call a gateway number of the first VOIP gateway.

The transceiver apparatus 304 is further configured to send the second call request to a second gateway, so that the second gateway forwards the second call request to the visited location GMSC and the visited location GMSC calls the destination identifier.

In another embodiment, the present invention further provides a call system.

Referring to FIG. 4, FIG. 4 is a block diagram of an embodiment of a call system according to the present invention. As shown in FIG. 4, the call system includes a home location GMSC 401, a VOIP server 402, and a visited location GMSC 403.

The home location GMSC 401 is configured to generate a first call request including a local identifier, and send the first call request to the VOIP server. The first call request may be generated after the home location GMSC receives a local call request used to call the local identifier. The home location GMSC may send the first call request to a first VOIP gateway, and then the first VOIP gateway forwards the first call request to the VOIP server.

The VOIP server 402 is configured to receive the first call request; acquire, according to a prestored association relationship, a destination identifier that corresponds to the local identifier; search for a visited location GMSC to which the destination identifier belongs; and send a second call request including the destination identifier to the visited location GMSC. The VOIP server may send the second call request to a second VOIP gateway, and then the second VOIP gateway forwards the second call request to the visited location GMSC.

The visited location GMSC 403 is configured to call the destination identifier after receiving the second call request.

During specific implementation, the present invention further provides a computer storage medium. The computer storage medium may store a program. When being executed, the program may include some or all steps in the embodiments of the call method provided by the present invention. The storage medium may be a magnetic disk, an optical disc, a read-only memory (Read-Only Memory, ROM), or a random access memory (Random Access Memory, RAM), or the like.

A person skilled in the art may clearly understand that, the technologies in the embodiments of the present invention may be implemented by software in addition to a necessary general hardware platform. Based on such an understanding, the technical solutions of the present invention essentially or the part contributing to the prior art may be implemented in a form of a software product. The software product is stored in a storage medium, such as a ROM/RAM, a hard disk, or an optical disc, and includes several instructions for instructing a computer device (which may be a personal computer, a server, or a network device) to perform the methods described in the embodiments or some parts of the embodiments of the present invention.

The embodiments in this specification are all described in a progressive manner, for same or similar parts in the embodiments, reference may be made to these embodiments, and each embodiment focuses on a difference from other embodiments. Especially, apparatus, server, and system embodiments are basically similar to a method embodiment, and therefore are described briefly; for related parts, reference may be made to partial descriptions in the method embodiment.

The foregoing descriptions are implementation manners of the present invention, but are not intended to limit the protection scope of the present invention. Any modification, equivalent replacement, and improvement made without departing from the spirit and principle of the present invention shall fall within the protection scope of the present invention.

What is claimed is:

1. A call method, comprising:
receiving, by a VOIP server, a first call request that is forwarded by a first VOIP gateway and that comprises a local identifier;
acquiring, by the VOIP server according to a prestored association relationship, a destination identifier that corresponds to the local identifier;
searching, by the VOIP server, for a visited location GMSC to which the destination identifier belongs; and
sending, by the VOIP server, a second call request comprising the destination identifier to the visited location GMSC, so that the visited location GMSC calls the destination identifier.

2. The method according to claim 1, wherein the receiving, by a VOIP server, a first call request that is forwarded by a first VOIP gateway and that comprises a local identifier comprises:
receiving, by the VOIP server, the first call request that is forwarded by the first VOIP gateway and that comprises the local identifier, wherein the first call request is generated by the home location GMSC and is used to call a gateway number of the first VOIP gateway.

3. The method according to claim 1 or 2, wherein the sending, by the VOIP server, a second call request comprising the destination identifier to the visited location GMSC comprises:
sending, by the VOIP server, the second call request to a second gateway, so that the second gateway forwards the second call request to the visited location GMSC.

4. A call method, comprising:
generating, by a home location GMSC, a first call request comprising a local identifier;
sending, by the home location GMSC, the first call request to a VOIP server;
acquiring, by the VOIP server according to a prestored association relationship, a destination identifier that corresponds to the local identifier;
searching, by the VOIP server, for a visited location GMSC to which the destination identifier belongs;
sending, by the VOIP server, a second call request comprising the destination identifier to the visited location GMSC; and
calling, by the visited location GMSC, the destination identifier after receiving the second call request.

5. The method according to claim 4, wherein the generating, by a home location GMSC, a first call request comprising a local identifier comprises:
generating, by the home location GMSC, the first call request comprising the local identifier after receiving a local call request used to call the local identifier.

6. The method according to claim 4 or 5, wherein the sending, by the VOIP server, a second call request comprising the destination identifier to the visited location GMSC comprises:
sending, by the VOIP server, the second call request comprising the destination identifier to a second VOIP gateway; and
receiving, by the visited location GMSC, the second call request forwarded by the VOIP server.

7. A call apparatus, comprising:
a receiving unit, configured to receive a first call request that is forwarded by a first VOIP gateway and that comprises a local identifier;
an acquiring unit, configured to acquire, according to a prestored association relationship, a destination identifier that corresponds to the local identifier received by the receiving unit;
a querying unit, configured to search for a visited location GMSC to which the destination identifier acquired by the acquiring unit belongs; and
a sending unit, configured to send a second call request comprising the destination identifier to the visited location GMSC obtained by querying by the querying unit, so that the visited location GMSC calls the destination identifier.

8. The apparatus according to claim 7, wherein:
the receiving unit is further configured to receive the first call request that is forwarded by the first VOIP gateway and that comprises the local identifier, wherein the first call request is generated by the home location GMSC and is used to call a gateway number of the first VOIP gateway.

9. The apparatus according to claim 7 or 8, wherein the call unit comprises:
the sending unit is configured to send the second call request to a second gateway, so that the second gateway forwards the second call request to the visited location GMSC and the visited location GMSC calls the destination identifier.

10. A VOIP server, comprising:
a transceiver apparatus, configured to receive a first call request that is forwarded by a first VOIP gateway and that comprises a local identifier; and
a processor, configured to acquire, according to a prestored association relationship, a destination identifier that corresponds to the local identifier, and search for a visited location GMSC to which the destination identifier belongs, wherein:
the transceiver apparatus is further configured to send a second call request comprising the destination identifier to the visited location GMSC, so that the visited location GMSC calls the destination identifier.

11. The server according to claim 10, wherein:
the transceiver apparatus is further configured to receive the first call request that is forwarded by the first VOIP gateway and that comprises the local identifier, wherein the first call request is generated by the home location GMSC and is used to call a gateway number of the first VOIP gateway.

12. The server according to claim 10 or 11, wherein:
the transceiver apparatus is further configured to send the second call request to a second gateway, so that the second gateway forwards the second call request to the visited location GMSC and the visited location GMSC calls the destination identifier.

13. A call system, comprising:
a home location GMSC, configured to generate a first call request comprising a local identifier, and send the first call request to a VOIP server;
the VOIP server, configured to receive the first call request; acquire, according to a prestored association relationship, a destination identifier that corresponds to the local identifier; search for a visited location GMSC to which the destination identifier belongs; and send a second call request comprising the destination identifier to the visited location GMSC; and
the visited location GMSC, configured to call the destination identifier after receiving the second call request.

14. The call system according to claim 13, wherein:
the home location GMSC is further configured to generate the first call request comprising the local identifier after receiving a local call request used to call the local identifier.
